(19) United States
(12) Patent Application Publication
(10) Pub. No.: US 2022/0058739 A1
(43) Pub. Date: Feb. 24, 2022

(54) SYSTEM AND METHOD FOR ASSET PORTFOLIO OPTIMIZATION

(71) Applicant: AllocateRite, LLC, New York, NY (US)

(72) Inventors: Quanzhen Ding, New York, NY (US); Michael Spece, New York, NY (US); Abbas Shah, New York, NY (US)

(21) Appl. No.: 17/405,076

(22) Filed: Aug. 18, 2021

Related U.S. Application Data
(60) Provisional application No. 63/067,517, filed on Aug. 19, 2020.

(51) Int. Cl. G06Q 40/06

(52) U.S. Cl. CPC G06Q 40/06; G06N 20/00

(57) ABSTRACT

An asset portfolio optimization platform is disclosed. An example embodiment is configured to: receive an asset portfolio; calculate a Sharpe Ratio; determine if the Sharpe Ratio is below a pre-defined threshold; and use a pure risk minimization strategy to optimize the asset portfolio, if the Sharpe Ratio is below the pre-defined threshold.

### CROSS-REFERENCE TO RELATED APPLICATIONS

This application claims the benefit of the filling date of U.S. Provisional Application Ser. No. 63/067,517 titled “SYSTEM AND METHOD FOR ASSET PORTFOLIO OPTIMIZATION” and filed Aug. 19, 2020, and the subject matter of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2019-2020, AllocateRite, LLC, All Rights Reserved.

### TECHNICAL FIELD

This patent document pertains generally to data processing, deep learning, machine learning and artificial intelligence (AI) systems, data communication networks, risk management, asset portfolio management, and more particularly, but not by way of limitation, to a system and method for intelligent machine learning optimization to operate on large volumes of dynamic content, such as asset portfolio optimization.

### BACKGROUND

Machine learning and artificial intelligence (AI) systems are becoming increasingly popular and useful for processing data and augmenting or automating human decision making in a variety of applications. For example, images and image analysis are increasingly being used for autonomous vehicle control and simulation, among many other uses. Statistical data and financial data are types of input that can be used to train an AI system to identify patterns and trends. However, AI systems have been inadequately used in the conventional technologies for effectively managing asset portfolios and assessing risk. As a result, conventional systems have been unable to harness the power of AI to efficiently manage investments. As the investment opportunity landscape continually changes, there is a greater need for new dynamic approaches that leverage innovations in asset portfolio design and risk management for small investors and for the larger institutions and hedge funds.

### BRIEF DESCRIPTION OF THE DRAWINGS

The various embodiments are illustrated by way of example, and not by way of limitation, in the figures of the accompanying drawings in which:

FIG. 1 illustrates an example embodiment of the asset portfolio optimization methodology as described herein for performing asset portfolio optimization according to a composite objective;

FIG. 2 illustrates a workflow in an example embodiment of the asset portfolio optimization platform for providing portfolio optimization with Sharpe Ratio and Standard Risk Conditional Value at Risk (CVaR);

FIG. 3 illustrates an example embodiment of the asset portfolio optimization methodology as described herein providing user adaptation;

FIG. 4 illustrates an example embodiment of the asset portfolio optimization platform of an example embodiment, which provides asset portfolio optimization using forecasted statistics produced by a trained densely-connected neural network, a convolutional neural network (CNN), or other similarly configured learning model; and

FIG. 5 is a process flow diagram illustrating an example embodiment of a system and method for implementing an asset portfolio optimization workflow.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

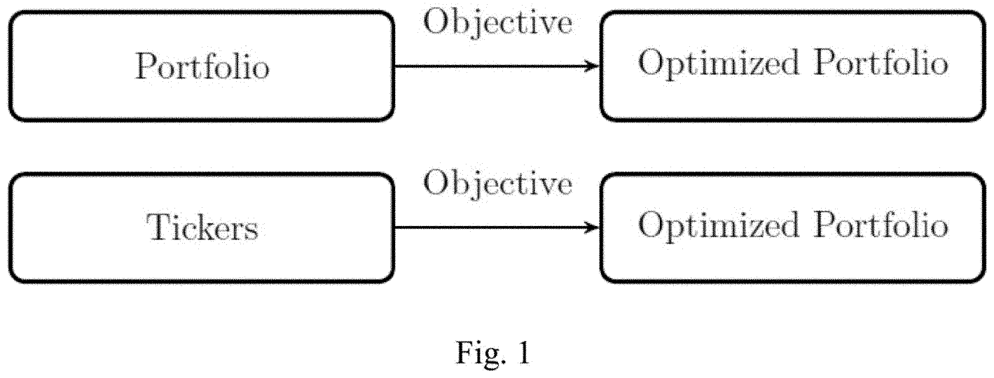

An asset portfolio optimization platform is disclosed. In the various example embodiments disclosed herein, an asset portfolio optimization system can be implemented to automate an investment strategy that is designed to realize optimized returns over longer term time horizons. This is accomplished by utilizing a new risk based approach to investing. Through dynamic diversification combined with real time rebalancing across different sectors and asset classes, users of the asset portfolio optimization system can over time achieve higher returns than most other broad market benchmarks. An important feature of the disclosed embodiments is to avoid market disruptions and offset and hedge risk, where possible. The asset portfolio optimization system provides the average retail investor a highly sophisticated Asset Allocation Model presented in a simple manner. The Asset Allocation Model evaluates fundamental and technical information and then runs this information through various workflows, processes, and statistical techniques as disclosed herein. A primary goal is to identify the low risk sectors while balancing overall exposures across equities, fixed income, and cash. Consequently, the asset portfolio attributes include diversification, high liquidity, low overall costs, and potential tax advantages. FIG. 1 illustrates an example embodiment of the asset portfolio optimization methodology as described herein for performing asset portfolio optimization according to a composite objective.

Referring to FIG. 1, the asset portfolio optimization platform of an example embodiment provides intelligent portfolio construction processes that deliver a better risk/reward profile than what users may have obtained on their own or currently have. The asset portfolio optimization platform of an example embodiment can be used for any collection of securities or asset portfolios. In general, the asset portfolio optimization platform receives a collection of securities or asset portfolios and optimizes the collection of securities or asset portfolios based on objectives explicitly and implicitly defined by a user as described in more detail below.

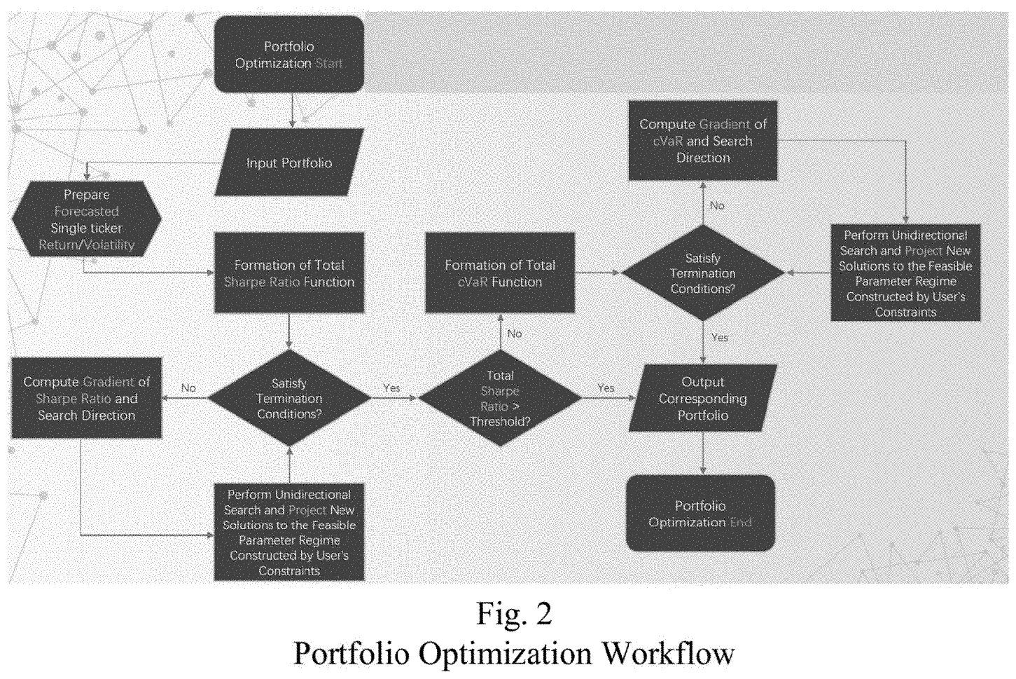

Referring to FIG. 2, the asset portfolio optimization platform of an example embodiment provides portfolio optimization with Sharpe Ratio and Standard Risk CVaR (defined below). Most finance people understand how to calculate the Sharpe Ratio and what it represents. The Sharpe Ratio describes how much excess return an investor receives for the extra volatility the investor endures for holding a riskier asset. It is understood that the investor needs compensation for the additional risk the investor takes for not holding a risk-free asset. The bottom-line risk and reward must be evaluated together when considering investment choices; this is the focal point presented in Modern Portfolio Theory. In a common definition of risk, the standard deviation or variance takes rewards away from the investor. As such, the risk should be assessed along with the reward when choosing investments. The Sharpe Ratio can help the investor determine the investment choice that will deliver the highest returns while considering risk.

VaR is a measurement and quantification of the potential level of financial downside risk within a portfolio or position over a specific time frame. VaR is the possible loss in value assuming “normal market risk” as opposed to all risks. More specifically, VaR is the statistical probability of the loss using a confidence interval defining the probability distributions of individual risks, the correlation across these risks, and the effect of such risks on the portfolio's value. For example, if an investor's 10-day 99% VaR is 10,000.00, there is considered to be only a 1% chance that losses will exceed $10,000.00 in 10 days.

Expected Shortfall (ES) or Conditional Value at Risk (CVaR) is a statistic used to quantify the risk of a portfolio. Given a certain confidence level, this measure represents the expected loss when it is greater than the value of the VaR calculated with that confidence level. The Conditional Value-at-Risk (CVaR) is closely linked to VaR. CVaR is the average of those values that fall beyond the expected VaR. This translates to the further potential of loss of an asset or portfolio. Riskier assets will exceed VaR by a more significant degree.

Referring still to FIG. 2, the asset portfolio optimization platform of an example embodiment provides a user with asset allocation recommendations (e.g., recommended asset buy or sell order) based on an analysis of the Sharpe Ratio and Standard Risk CVaR related to one or more asset portfolios. The input provided to the asset portfolio optimization workflow is a set of portfolio assets, which may include various types, such as: options, tickers, exchange-traded funds (ETFs), any type of securities, and the like. As shown in FIG. 2, the asset portfolio optimization workflow of an example embodiment can use this input to calculate the Sharpe Ratio (e.g., for a single and aggregated total). The Sharpe Ratio and Risk are natural objectives. However, it would not be apparent to one of ordinary skill in the art absent the present disclosure that it would be beneficial to combine the Sharpe Ratio and Risk values nor how to do so. As shown in FIG. 2, if the total Sharpe Ratio is below a certain pre-defined and configurable threshold (e.g., 0.1), the potential reward is relatively low. In this case, there is utility in reverting to a purely risk minimization strategy (the combination). As shown in FIG. 2, if the total Sharpe Ratio is below the pre-defined and configurable threshold, the asset portfolio optimization workflow of an example embodiment computes the total CVaR to assess the risk level. As such, the asset portfolio optimization workflow of an example embodiment uses a pure risk minimization strategy if the potential reward is relatively low. In this manner, the asset portfolio optimization workflow can use a combination of the Sharpe Ratio and CVaR Risk values to produce a more targeted objective and more optimized asset allocation recommendations for a user. This feature of the example embodiments disclosed herein is a benefit not provided by conventional systems. This targeted objective can be used to produce asset allocation recommendations to transform a set of tickers or an asset portfolio, for example, into a new more optimized portfolio.

The asset portfolio optimization workflow can be configured to be run on a particular asset portfolio on an on-going or periodic basis. This repeated asset portfolio optimization workflow enables the particular asset portfolio to be rebalanced on a periodic (or one-shot) basis. In a particular example embodiment, a 30-day rebalancing frequency (e.g., one month) can be used; but, this rebalancing frequency is adjustable or could be used on a one-shot basis. The relevance of the rebalance frequency is the horizon used in the forecasted statistics. For example, most statistics forecast the following 22 trading days, nearly equal to 22 business days.

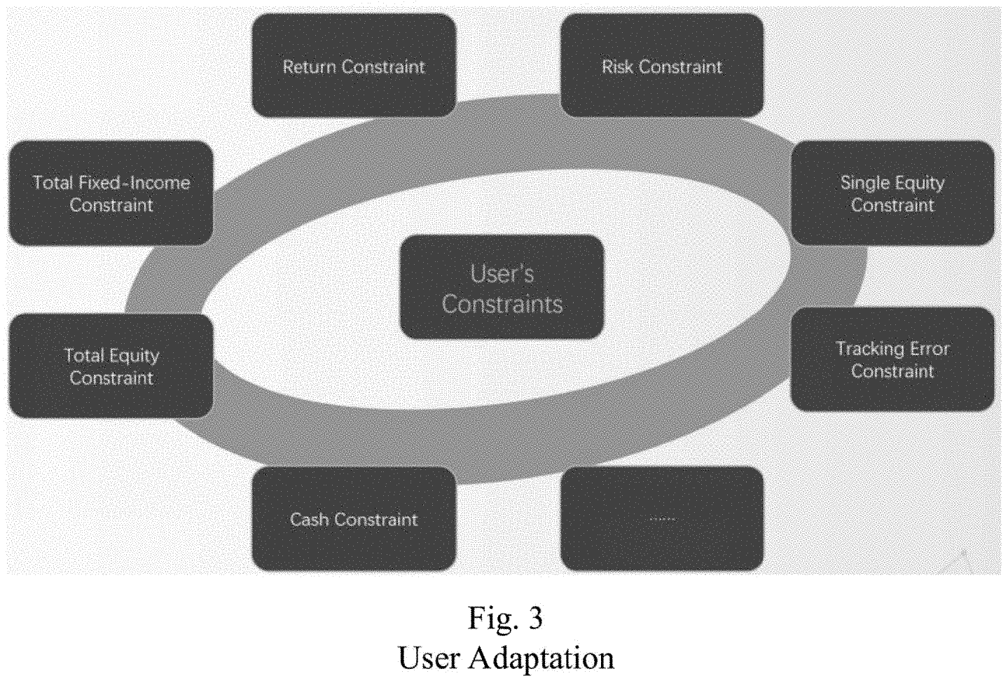

Referring now to FIG. 3, the asset portfolio optimization platform of an example embodiment also provides a user with user interface controls to configure and adapt the asset portfolio optimization workflow according to a particular user's goals or objectives. These particular user goals or objectives can be received via the user interface of the asset portfolio optimization platform and converted to corresponding constraints, which can be used by the asset portfolio optimization workflow to modify the workflow and/or the calculation of values through the workflow in accordance with the user's goals or objectives. For example, as shown in FIG. 3, these constraints can include: a total fixed-income constraint (e.g., minimum and maximum income limits), a return constraint, a risk level constraint, a single equity constraint, a total equity constraint, a cash constraint, a tracking error tolerance constraint (e.g., S&P500), or the like. Allowing the user to configure particular user goals or objectives via the user interface of the asset portfolio optimization platform enables a user to define various goals, including: maximizing return, minimizing risk, imposing a return constraint for minimizing risk or maximizing the Sharpe Ratio, or imposing a risk constraint for maximizing risk or the Sharpe Ratio. Users can also add constraints like total equities/fixed-income/cash in certain ranges, single equity must be less than a certain percentage, etc. More constraints like boundaries of dispersions, return cannot be less than one value, risk cannot exceed one value are also provided. Users can freely select any combinations of constraints to meet their needs.

Providing user interface controls to enable a user to configure and adapt the asset portfolio optimization workflow as described above is one feature for explicit user customization provided by the asset portfolio optimization platform of an example embodiment. This feature enables explicit user-driven customization. However, the asset portfolio optimization platform of an example embodiment also provides implicit user customization driven by an automated process of analyzing the user risk characteristics based on portfolio analysis and an assessment of user risk/reward objectives and responses to portfolio optimizations. The implicit user customization of an example embodiment enables an automated portfolio optimization workflow that produces user-specific portfolio optimization at any configured frequency without explicit user configuration input. The implicit user customization can produce an optimized asset portfolio for a particular user based on a user's existing portfolio (e.g., based on the tickers in that portfolio or even the allocation percentages by incorporating them into constraints, which can modify the operation of the asset portfolio optimization workflow.

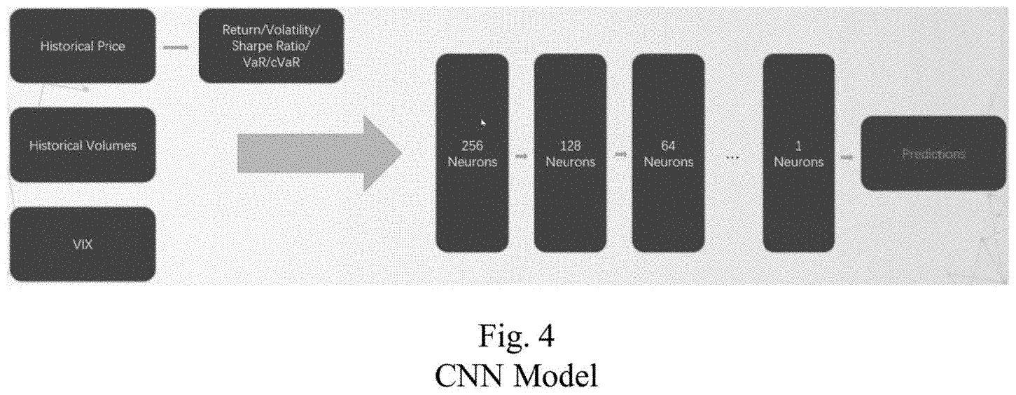

Referring now to FIG. 4, the asset portfolio optimization platform of an example embodiment also provides asset portfolio optimization using forecasted statistics produced by a trained densely-connected neural network, a convolutional neural network (CNN), or other similarly configured learning model. In the example embodiment, the neural network or other learning model can use historical price, volume, volatility data and other statistics to forecast return, risk, and other parameters for particular assets or asset classes. The forecast return, risk, and other parameters can be used to form a Sharpe Ratio, VaR, and CVaR forecast. Alternatively, single ticker Sharpe Ratio, VaR, and CVaR forecasts can also be generated. The learning model of an example embodiment also provides parameter tuning to further configure the operation of the model in producing the forecast parameters.

As shown in FIG. 4, the learning model of an example embodiment can include nine layers through which the historical price, volume, volatility data, Sharpe Ratio, VaR, and CVaR statistics/parameters can be processed. Based on the effectiveness of the training data used to train the learning model, the neural network can generate predictions to forecast return, risk, and other parameters for particular assets or asset classes. The neural network can generate predictions using feedback between the layers resulting in machine learning. The number of layers can be based on risk measures and performance speed.

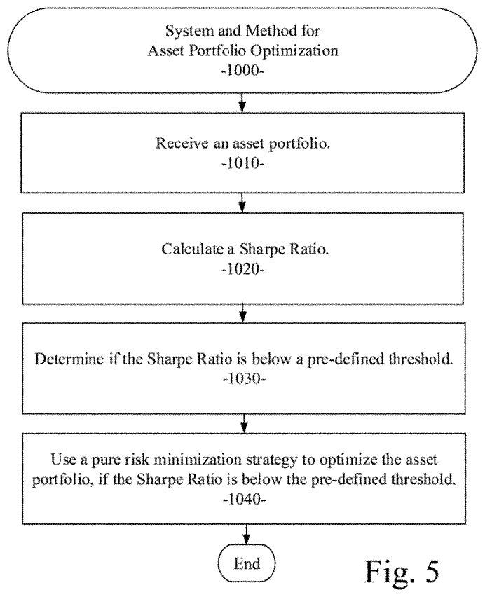

Referring now to FIG. 5, a flow diagram illustrates an example embodiment of a system and method 1000 for asset portfolio optimization. The example embodiment can be configured to: receive an asset portfolio (processing block 1010); calculate a Sharpe Ratio (processing block 1020); determine if the Sharpe Ratio is below a pre-defined threshold (processing block 1030); and use a pure risk minimization strategy to optimize the asset portfolio, if the Sharpe Ratio is below the pre-defined threshold (processing block 1040).

Glossary of Terms

| Term | Definition |
|---|---|
| Artificial Intelligence | Is conventionally, if loosely, defined as intelligence exhibited by |
| (AI) | machines. |
| Allocation | AllocateRite's terminology used to incorporate the generation of |
| | proposed buy-sell signals/trades of individual securities by its |
| | dynamic algorithmic model to properly rebalance portfolios |
| Broker | Financial Institutions that buys and sells securities (executing |
| | broker) and/or holds custody of financial assets (custodian |
| | broker). |
| Composite | An aggregation of one or more portfolios managed according to |
| | a similar investment mandate, objective, or strategy and is the |
| | primary vehicle for presenting performance to prospective |
| | clients. |
| Current Value | The summation of quantity multiplied by price of all securities |
| | held within a portfolio on that same day. |
| Dynamic Asset | A portfolio management strategy that frequently adjusts the mix |
| Allocation | of asset classes to better manage risks in varying market |
| | conditions. |
| Equities | Common stocks (ordinary shares) traded in a securities market. |
| ETF | An exchange-traded fund (ETF) is a collection of securities you |
| | buy or sell through a brokerage firm on a stock exchange. ETFs |
| | are offered on virtually all asset classes ranging from traditional |
| | investments to alternative assets. |
| Financial Crisis | The crisis risk is essentially a max downside risk over a window |
| | of time that goes back to either the (i) Financial Crisis or (ii) |
| | earliest IPO among a portfolio's tickers, whichever is most recent |
| Fixed Income | Type of debt instrument that provides returns in the form of |
| | regular, or fixed, interest payments and repayments of the |
| | principal when the security reaches maturity. Instruments are |
| | issued by governments, corporations, and other entities to |
| | finance their operations |
| Global Macro Model | Based on global technical and/or fundamental analysis to |
| | directionally position a portfolio across a broad range of markets |
| | and/or asset classes. Fundamental factors evaluate opportunities |
| | based on criteria such as valuation metrics, economic forecasts, |
| | interest rate and currency outlooks, and fiscal and monetary |
| | policy. The information employed may be macro-economic or |
| | the aggregation of micro-level information. These managers tend |
| | to be close followers of academia, particularly econometrics. • |
| | Technical factors utilize predictive signals that are generated |
| | from market-related information (e.g., price, volume), and often |
| | involve the use of pattern recognition and other types of |
| | advanced statistical forecasting tools |
| Inception Date | Starting date of when capital was invested for a specific account |
| ITD | Inception to Date |
| Initial Capital | The starting investment monies contributed to a specific account |
| Liquidity | A high volume of activity in a financial marketplace/exchange |
| Long Only | Term used to identify portfolios that buy “long” positions in |
| | assets and securities. To be “long” an asset, derivative or security |
| | means being a buyer, generally one who benefits from an |
| | increase in prices |
| LTD | Life to Date |
| MTD | Month to Date |
| Re-balance | AllocateRite's terminology used to incorporate the generation of |
| | proposed buy-sell signals/trades/allocation percentages of |
| | individual securities for a portfolio or set of portfolios by its |
| | dynamic algorithmic model |
| Return/Performance | The quantification of total gains and losses over the account's |
| | equity for a designated time frame |
| Strategy | AllocateRite's terminology used to identify a subset within one |
| | of AllocateRite's Composites based on a set of characteristics |
| | that would constitute distinct portfolio group |
| YTD | Year to Date |
| Value | Shorthand for Market Value |
| AI Based Overall | A composite risk score based on the geometric average of the |
| Portfolio Risk Forecast | expected and crisis risks |
| Maximum Potential | Is the maximum potential loss of value a current portfolio could |
| Loss | incur under extreme conditions as calculated by AR AI risk |
| | forecaster |
| Drawdown (Potential | The maximum loss in the portfolio's value from peak to trough. |
| Loss) | This is an indicator of risk in a specific portfolio |
| Expected Risk | Also known as Expected Shortfall (ES) or Conditional Value at |
| | Risk (CVaR) is a statistic used to quantify the risk of a portfolio. |
| | Given a certain confidence level, this measure represents the |
| | expected loss when it is greater than the value of the VaR |
| | calculated with that confidence level. The Conditional Value-at- |
| | Risk (CVaR) is closely linked to VaR. It is simply the average of |
| | those values that fall beyond the expected VaR. This translates to |
| | the further potential of loss of an asset or portfolio. Riskier assets |
| | will exceed VaR by a more significant degree |
| Liquidity Risk | Risk that the organizing company or bank may be unable to meet |
| | short term financial demands. This usually occurs due to the |
| | inability to convert a security or hard asset to cash without a loss |
| | of capital and/or income in the process |
| Maximum Downside | Traditionally known as drawdown, the downside risk historically |
| Risk | measures the loss between portfolio highs and lows. The |
| | maximum of these measurements (over a given window of time) |
| | represents the risk from mistiming the market. In the |
| | RiskMonkey max downside risk plot, this window is |
| | approximately 2.5 years |
| Maximum Historical | The max loss suffered by the portfolio since 2007 with |
| Drawdown | historically monthly dynamic portfolio rebalancing. The |
| | portfolio was rebalanced monthly |
| Correlation with S&P | A number from 0 to 1 that reveals how closely a portfolio tracks |
| Forecast | the benchmark (S&P) |
| Risk | AllocateRite's calculation of potential risk of loss in a portfolio |
| | based on sophisticated dynamic computations using proprietary |
| | statistical and AI based modeling tools. AllocateRite calculates |
| | its own VaR and CVaR using this methodology |
| VaR | A measurement and quantification of the potential level of |
| | financial downside risk within a portfolio or position over a |
| | specific time frame. It is the possible loss in value assuming |
| | “normal market risk” as opposed to all risks. More specifically, it |
| | is the statistical probability of the loss, using a confidence |
| | interval, defining the probability distributions of individual risks, |
| | the correlation across these risks and the effect of such risks on |
| | the portfolio's value. For example, if an investor's 10-day 99% |
| | VAR is $10,000.00, there is considered to be only a 1% chance |
| | that losses will exceed $10,000.00 in 10 days |
| Correlation | Statistical measure of the degree to which the movements of two |
| | variables are related |
| Dispersion | A term used in statistics that refers to the location of a set of |
| | values relative to a mean or average level. In finance, dispersion |
| | is used to measure the volatility of different types of investment |
| | strategies. Returns that have wide dispersions are generally seen |
| | as more risky because they have a higher probability of closing |
| | dramatically lower than the mean. In practice, standard deviation |
| | is the tool that is generally used to measure the dispersion of |
| | returns |
| Fundamental Inputs | Use valuation techniques and macroeconomic variables as inputs |
| (basis for investment | to investment decisions |
| views) | |
| Overbought | An indicator that a given security's price has become abnormally |
| | high and, thereby, potentially expensive |
| Oversold | An indicator that a given security's price has become abnormally |
| | low and, thereby, potentially cheap |
| Momentum (MOM) | Indicates whether a given security's price has an upward (icon), |
| | downward (icon), or neutral (icon) trend, based on the recently |
| | observed acceleration of the stock's return. It is upward if the |
| | security has positive acceleration but is not overbought; |
| | downward if the given security has negative acceleration but is |
| | not oversold; and neutral otherwise. Note these trends only factor |
| | in price movements, not necessarily fundamental changes in |
| | either the market or the underlying assets of the security; such |
| | trends are said to be purely technical. As historical measures, |
| | they are subject to reversal at any time and are not |
| | recommendations |
| Stacking/Layering | An algorithm that takes the outputs of sub-models as input and |
| | attempts to learn how to best combine the input predictions to |
| | make a better output prediction. |
| Systematic Style | No human intervention in trade generation |
| (application of views) | |
| Technical Inputs (basis | Employ market-based (e.g., price and volume) information as |
| for investment views) | inputs to trading decisions |
| Volatility or VIX | A statistical measure of the tendency of a market or security to |
| | rise or fall sharply within a period of time - usually measured by |
| | standard deviation |

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An asset portfolio optimization system, the system comprising:
a data processor; and
an asset portfolio optimization platform, executable by the data processor, the asset portfolio optimization platform being configured to:
receive an asset portfolio;
calculate a Sharpe Ratio;
determine if the Sharpe Ratio is below a pre-defined threshold; and
use a pure risk minimization strategy to optimize the asset portfolio, if the Sharpe Ratio is below the pre-defined threshold.

2. The asset portfolio optimization system of claim 1 being further configured to enable a user to provide explicit adaptation input to configure an asset portfolio optimization workflow.

3. The asset portfolio optimization system of claim 1 being further configured to obtain implicit information related to user goals and objectives to configure an asset portfolio optimization workflow.

4. The asset portfolio optimization system of claim 1 being further configured to include a nine-layer learning model to generate forecast return, risk, and other parameters for particular assets or asset classes.
